(19) United States
(12) Patent Application Publication
(10) Pub. No.: US 2025/0076227 A1
(43) Pub. Date: Mar. 6, 2025

(54) METHOD OF MANUFACTURING A COMPONENT TO REDUCE RISK OF COLD DWELL FATIGUE FAILURE

(71) Applicant: Rolls-Royce Corporation, Indianapolis, IN (US)

(72) Inventors: Michael Glavicic, Indianapolis, IN (US); Daniel L. Motter, Indianapolis, IN (US); Joshua B. Kolman, Indianapolis, IN (US); David E. Mills, Indianapolis, IN (US)

(21) Appl. No.: 18/818,195

(22) Filed: Aug. 28, 2024

Related U.S. Application Data
(60) Provisional application No. 63/534,897, filed on Aug. 28, 2023.

(51) Int. Cl. G01N 23/203; C22C 14/00; C22F 1/18

(52) U.S. Cl. CPC G01N 23/203; C22C 14/00; C22F 1/183; G01N 2223/053; G01N 2223/30; G01N 2223/60

(57) ABSTRACT

A method of manufacturing a component including a metal alloy comprises measuring crystallographic texture of a volume of a component, determining a risk factor of the component for cold dwell fatigue failure, and adjusting metallurgical processing of the component based on the risk factor. Such risk analysis and mitigation may aid in improving the usage and operation of components including materials that are susceptible to cold dwell fatigue failure.

### CROSS-REFERENCE TO RELATED APPLICATIONS

This nonprovisional application claims the benefit and priority, under 35 U.S.C. § 119(e) and any other applicable laws or statues, to U.S. Provisional Patent Application Ser. No. 63/534,897 filed on Aug. 28, 2023, the entire disclosure of which is hereby expressly incorporated herein by reference.

### TECHNICAL FIELD

The present disclosure relates generally to a method for manufacturing a metal alloy component to reduce the risk of mechanical failure, particularly the risk of cold dwell fatigue failure.

### BACKGROUND

Titanium (Ti) has two dominant crystallographic phases, alpha (α) and beta (β). The alpha phase of titanium is hexagonal close-packed (HCP) and the beta phase is body centered cubic (BCC). Below 882° C., pure titanium consists entirely of the alpha phase; above 882° C., pure titanium consists entirely of the beta phase. Alloying elements may be used to alter the transformation temperature and produce a two-phase field in which both the alpha and beta phases are present. Elements such as vanadium (V), molybdenum (Mo), iron (Fe), chromium (Cr) and manganese (Mn) are known as beta stabilizers, and elements such as aluminum (Al), oxygen (O), nitrogen (N) and carbon (C) are known as alpha stabilizers. The alpha phase may also be strengthened by additions of tin (Sn) or zirconium (Zr). The most widely used titanium alloys are a/P alloys, in particular, Ti-6Al-4V and Ti-6Al-2Sn-4Zr-2Mo (“Ti 6242”)

Due to their light weight, high strength and corrosion resistance, titanium alloys such as Ti-6Al-4V are employed in the aerospace industry for engine components such as fan hubs. It has recently been recognized that Ti-6Al-4V may be susceptible to cold dwell fatigue failure. Accordingly, there has been interest in reevaluating various engine components for their risk to cold dwell fatigue.

### SUMMARY

The present disclosure may comprise one or more of the following features and combinations thereof.

According to a first aspect of the present disclosure, a method of manufacturing a component comprising a metal alloy includes measuring crystallographic texture of a volume of the component, determining a risk factor of the component for cold dwell fatigue failure, and adjusting metallurgical processing of the component based on the risk factor.

In some embodiments, the component is a forged component.

In some embodiments, the component comprises a titanium alloy.

In some embodiments, the titanium alloy comprises Ti-6Al-4V, Ti-6Al-2Sn-4Zr-2Mo (“Ti 6242”), Ti-5.8Al-4.0Sn-3.5Zr-0.5Mo-0.4Si-0.3Nb-1.0Ta-0.8W-0.05C (“Ti65”), Ti-5.8Al-4.0Sn-3.5 Zr-0.7Nb-0.50Mo-0.35Si-0.06C (“IMI-834”), or another dwell-sensitive titanium alloy.

In some embodiments, measuring crystallographic texture comprises obtaining electron backscatter diffraction (EBSD) data from the volume.

In some embodiments, the method further includes processing the EBSD data to obtain pole figures, inverse pole figure maps, orientation distribution functions, and/or misorientation distribution function.

In some embodiments, the method further includes using processed EBSD data, generating a list of microtexture region sizes detected in the volume.

In some embodiments, the method further includes determining microtexture region size distributions from maps of the EBSD data.

In some embodiments, the volume of the component includes first microtexture regions comprising a hard crystallographic orientation with respect to a stress axis, second microtexture regions comprising a soft crystallographic orientation with respect to the stress axis, and/or a third microtexture regions comprising an initiator crystallographic orientation with respect to the stress axis.

In some embodiments, the first, second and third microtexture regions have a hexagonal close packed (HCP) crystal structure.

In some embodiments, determining the risk factor includes determining a probability P(A), determining a probability P(B), determining a probability P(C), and obtaining a product of the probabilities P(A), P(B), and P(C). The probability P(A) is a probability of the first microtexture regions contacting the second microtexture regions, the probability P(B) is a probability of the third microtexture regions contacting the first or second microtexture regions, and the probability P(C) is a probability that each of the first, second, and third microtexture regions has a predetermined alignment within the volume.

In some embodiments, determining P(C) includes determining a probability Prob_{hard} of occurrence of the hard crystallographic orientation having a first predetermined alignment within the volume, the first predetermined alignment being a c-axis orientation with respect to the stress axis within a first angular range from 0 to 25 degrees, or from 0 to 5 degrees, determining a probability Prob_{soft} of occurrence of the soft crystallographic orientation having a second predetermined alignment within the volume with respect to experimentally observed slip system activity in polycrystalline materials using Schmid factors, the second predetermined alignment being a c-axis orientation with respect to the stress axis within a second angular range from 80 to 90 degrees, determining a probability Probᵢₙᵢₜ of occurrence of the initiator crystallographic orientation having a third predetermined alignment within the volume with respect to experimentally observed slip system activity in polycrystalline materials using Schmid factors, the third predetermined alignment being a c-axis orientation with respect to the stress axis within a third angular range from 40 to 50 degrees, and calculating a product of the probabilities Prob_{hard}, Prob_{soft}, Probᵢₙᵢₜ to obtain the probability P(C).

In some embodiments, determining the probabilities Prob_{hard}, Prob_{soft}, and Probᵢₙᵢₜ includes determining an orientation distribution function from measurements of the crystallographic texture, and calculating, for each of the first, second, and third microtexture regions, a probability of a specific set of orientations, dV/V, whose crystal orientation varies from g to g′ within a volume of possible orientations n described by the orientation distribution function:

$$\frac{d V}{V} = \frac{{Σ}_{g}^{{g}^{′}} g}{{Σ}_{n = 1}^{n} g}$$

In some embodiments, determining the probability P(A) includes obtaining a misorientation distribution function from measurements of the crystallographic texture, integrating the misorientation distribution function between eighty and ninety-three degrees to obtain a value, and dividing the value by a total area underneath the misorientation distribution function.

In some embodiments, determining the probability P(B) includes obtaining a misorientation distribution function from measurements of the crystallographic texture, integrating the misorientation distribution function between forty and fifty degrees to obtain a value, and dividing the value by a total area underneath the misorientation distribution function.

In some embodiments, the method further includes determining a probability P(MTR_{size}, Volume) of the first, second and third microtexture regions being aligned along the stress axis within a volume of the component above a stress threshold, and multiplying the product of the probabilities P(A), P(B), and P(C) by the probability P(MTR_{size}, Volume).

In some embodiments, the method further includes scaling the risk factor with a first scaling factor f(% YS,MTR_{Size},% Primary Alpha) representing a local stress state and microstructure of the metal alloy, scaling the risk factor with a second scaling factor f(temp) based on an operating temperature of the component, scaling the risk factor with a third scaling factor f(dwell time) based on a dwell time of the component at a predetermined load, and/or scaling the risk factor with fleet data.

In some embodiments, adjusting the metallurgical processing of the component includes altering a cooling rate during solution heat treatment to change a primary alpha content of the titanium alloy.

In some embodiments, adjusting the metallurgical processing of the component includes altering die geometry to change an amount of strain imparted during forging, thereby altering microtexture region size.

In some embodiments, adjusting the metallurgical processing of the component includes altering a supply of billet material to control an amount of strain prior to forging and/or an oxygen content of the titanium alloy.

These and other features of the present disclosure will become more apparent from the following description of the illustrative embodiments.

### BRIEF DESCRIPTION OF THE DRAWINGS

The embodiments may be better understood with reference to the following drawing(s) and description. The components in the figures are not necessarily to scale. Moreover, in the figures, like-referenced numerals designate corresponding parts throughout the different views.

FIG. 1 provides a flow chart of a method of manufacturing a component of a metal alloy that includes determining a risk factor for cold dwell fatigue failure;

FIG. 2 shows a representative misorientation distribution function obtained by processing electron backscatter diffraction (EBSD) data;

FIG. 3A shows a first orientation considered “hard” for the known stress field based on its c-axis alignment;

FIG. 3B shows a second orientation that is considered “soft” for the known stress field based on its c-axis alignment; and

FIG. 3C shows a third orientation that is considered to be an “initiator” for the known stress field based on its c-axis alignment;

FIG. 4 provides an example of the determination of P(A) and P(B) utilizing a misorientation distribution function;

FIG. 5 shows the three bad crystallographic orientations dwell debit for three locations, and the dwell debit factor as a function of normalized microtexture region (MTR) size;

FIG. 6 shows the behavior of the second scaling factor f(dwell time) for a variety of loads with respect to the yield strength of the material;

FIG. 7 plots normalized dwell debit as a function of normalized temperature; and

FIG. 8 shows a regression fitting of selected data from FIG. 7 in normalized form.

### DETAILED DESCRIPTION

A new methodology has been developed to evaluate the relative risk of locations in a metal alloy forging stressed above the cold dwell threshold (CDT) to fatigue failure. Once the risk has been assessed, process adjustments may be made to increase the safety margin of the forged component.

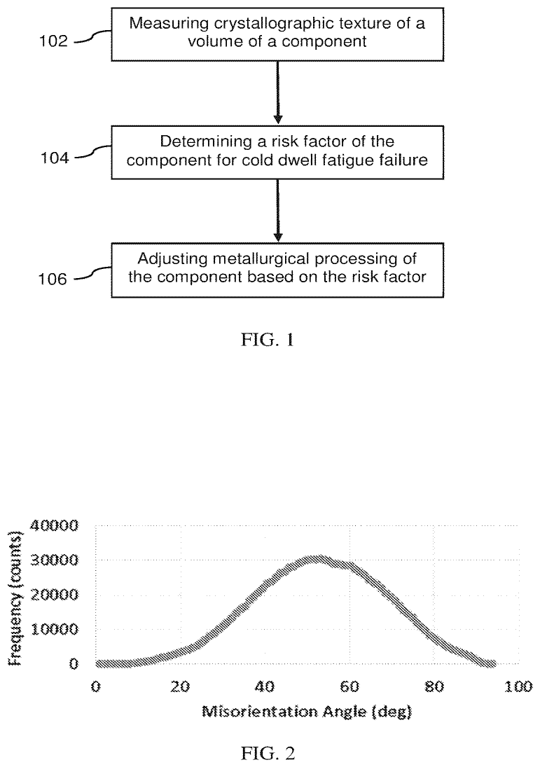

Accordingly, referring to the flow chart of FIG. 1, described in this disclosure is a method of manufacturing a component comprising a metal alloy that entails: measuring 102 crystallographic texture of a volume of a component; determining 104 a risk factor of the component for cold dwell fatigue failure; and adjusting 106 metallurgical processing of the component based on the risk factor. It is understood that adjustments of the metallurgical processing of “the component” may refer to process adjustments that affect (a) the particular component that underwent the risk analysis and/or (b) like components, which may be produced at the same time or at a later time. The component may be a forged component, and the metal alloy is typically a titanium alloy.

This new approach considers the texture of the metal alloy under load and how that impacts the probability of getting a combination of crystallographic features believed to be required for cold dwell fatigue failure within a stressed volume. Other parameters that may considered in the analysis include the load of the material under operation in relation to its yield strength; the volume of material under operation that is above a stress threshold for cold dwell fatigue; and the size of the microtexture regions (MTRs) and the primary alpha content of the material under load. The stress threshold may be determined based on mechanical test data, e.g., see M. R. Bache, International Journal of Fatigue, vol. 25, issues 9-11 (2003) pp. 1079-1087.

As mentioned above, the most widely used titanium alloys are a/P alloys, in particular, Ti-6Al-4V and Ti-6Al-2Sn-4Zr-2Mo (“Ti 6242”). Other titanium alloys that may be dwell-sensitive include Ti-5.8Al-4.0Sn-3.5Zr-0.5Mo-0.4Si-0.3Nb-1.0Ta-0.8W-0.05C (“Ti65”) and Ti-5.8Al-4.0Sn-3.5 Zr-0.7Nb-0.50Mo-0.35Si-0.06C (“IMI-834”), where the preceding alloy compositions are given in weight percent. These titanium alloys may be produced by forming a melt including titanium and the requisite alloying elements (e.g., aluminum and vanadium), cooling the melt to form a solidified ingot, followed by hot working and heat treatment steps to form mill products such as billets, plate or sheet. The microstructure and crystallographic texture developed during mill processing may undergo further changes during forging, extrusion and/or other forming operations, which may be followed by heat treatment(s). The components of interest for this analysis are metal alloy forgings, as indicated above. Given their elevated temperature strength and relatively low density, titanium alloy forgings in particular are used in a number of gas turbine engine components, such as fan disks and blades.

Referring again to the flow chart of FIG. 1, the method includes measuring 102 crystallographic texture of a volume of a component, which may entail obtaining electron backscatter diffraction (EBSD) data from the volume using a scanning electron microscope (SEM) equipped with an EBSD detector. The volume may be a stressed volume known to experience stresses above the stress threshold. The volume that is analyzed to measure crystallographic texture may be referred to as the “sample” or “specimen” below. To conduct the risk analysis described in this disclosure, EBSD data are preferred for crystallographic texture measurement, and x-ray and neutron diffraction are typically not used. This is because x-ray and neutron diffraction provide no data with respect to how individual crystals of a polycrystalline aggregate contact each other.

In EBSD, an electron beam interacts with crystals in the volume of interest, and Kikuchi diffraction patterns are produced. EBSD data are collected and analyzed as the electron beam is moved and/or the specimen is moved. At each analysis location of an EBSD scan, the crystallographic orientation of a crystal (or grain) is recorded as a set of Euler angles (φ₁, Φ, Φ₂) along with their X-Y coordinates within the specimen reference frame. Accordingly, the data collected in the EBSD scan may correspond to a set of pixel coordinates and their associated Euler angles. These data sets may be presented in a color format or map in which regions of the same crystal orientations have the same color.

The EBSD data may be processed to obtain pole figures, inverse pole figure maps, and/or orientation distribution functions, any or all of which may may be utilized in the risk analysis as discussed below. Using the processed EBSD data, a list of microtexture region sizes detected in the volume may be generated. This tabulated data may be contained within an Excel CSV file. Microtexture region size distributions may be obtained from maps of the EBSD data. Because the data collected in EBSD include spatial awareness of crystal orientations that are touching one another, the EBSD data may also or alternatively be processed in a manner that provides a misorientation distribution function, a representative example of which is provided in FIG. 2. This type of a distribution function describes the frequency of crystals of different orientations contacting one another in the measured data set. As a result, the probability of specific misorientations occurring in the volume of interest may be estimated by dividing the area underneath a range of misorientation angles by the area underneath the entire distribution.

Referring again to the flow chart of FIG. 1, the method also includes determining 104 a risk factor of the component for cold dwell fatigue failure.

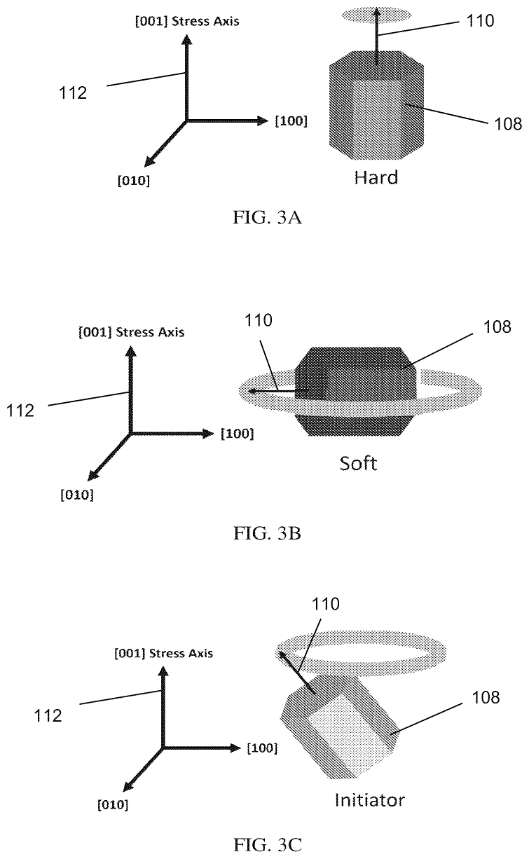

The risk that an embedded flaw could cause a cold dwell failure in a titanium alloy such as Ti-6Al-4V or Ti 6242 may be referred to as a “three bad crystallographic orientations” risk, as it depends on the probability that three crystallographic entities are touching one another and oriented in a specific fashion within a volume of a component that is stressed above a particular stress threshold. In this formulation, the three bad crystallographic orientations of a crystal (e.g. crystal 108 in FIGS. 3A-3C) refer to a first crystallographic orientation that is considered “hard” for the known stress field, a second crystallographic orientation that is considered “soft” for the known stress field, and a third crystallographic orientation that is considered to be an “initiator” for the known stress field and whose hard (c-axis 110) direction is aligned at roughly 45 degrees to the applied stress field, as illustrated in FIGS. 3A-3C. In this analysis, the volume of the component may include first microtexture regions (crystal 108) comprising the first (hard) crystallographic orientation with respect to the stress axis 112, second microtexture regions (crystal 108) comprising the second (soft) crystallographic orientation with respect to the stress axis 112, and/or third microtexture regions (crystal 108) comprising the third (initiator) crystallographic orientation with respect to the stress axis 112. The first, second and third microtexture regions may have the HCP crystal structure, consistent with the alpha phase of the titanium alloy.

Determining 104 the risk factor may thus comprise: determining a probability P(A) of the first microtexture regions (hard crystallographic orientations) contacting the second microtexture regions (soft crystallographic orientations); determining a probability P(B) of the third microtexture regions (initiator crystallographic orientations) contacting the first or second microtexture regions; determining a probability P(C) that each of the first, second, and third microtexture regions have a predetermined orientation within the volume; and then calculating a product of the probabilities P(A), P(B), P(C), where P(A)·P(B)·P(C)=risk factor. Determination of P(C) may utilize the orientation distribution function and determination of P(A) and P(B) may utilize the misorientation distribution function, both obtained from EBSD data.

### Determination of Probability P(C)

Determining the probability P(C) may entail: (a) determining a probability Prob_{hard} of occurrence of hard crystallographic orientations having a first predetermined alignment within the volume; (b) determining a probability Prob_{soft} of the occurrence of soft crystallographic orientations having a second predetermined alignment within the volume with respect to experimentally observed slip system activity in polycrystalline materials using Schmid factors; (c) determining a probability Probᵢₙᵢₜ of the occurrence of initiator crystallographic orientations having a third predetermined alignment within the volume with respect to experimentally observed slip system activity in polycrystalline materials using Schmid factors; and (d) calculating the probability P(C)=Prob_{hard}·Prob_{soft}·Probᵢₙᵢₜ; that is, calculating the product of Prob_{hard}, Prob_{soft}, and Probᵢₙᵢₜ to arrive at P(C).

As indicated above, the first, second and third crystallographic regions having the hard, soft and initiator orientations may have a HCP crystal structure. FIGS. 3A-3C show what are referred to as “three bad crystallographic orientations.” The first predetermined alignment (“hard”) may be a c-axis 110 orientation of the crystal 108 (i.e. the crystallographic region or the microtexture region) with respect to the stress axis 112 within a first angular range from 0 to 5 degrees (see FIG. 3A). The second predetermined alignment (“soft”) of the crystal 108 (i.e. the crystallographic region or the microtexture region) may be a c-axis 110 orientation with respect to the stress axis 112 within a second angular range from 80 to 90 degrees (see FIG. 3B). The third predetermined alignment (“initiator”) of the crystal 108 (i.e. the crystallographic region or the microtexture region) may be a c-axis 110 orientation with respect to the stress axis 112 within a third angular range from 40 to 50 degrees (see FIG. 3C).

The concept of hard and soft is linked to the slip systems (basal, prismatic, and pyramidal) available in HCP materials and the relative critical resolved shear stress that is required for slip to occur on each of these slip systems. The relative stress required for the three slip systems to be activated under an applied load is not the same, and the slip systems also vary as a function of temperature and alloy composition. Hence, the deformation behavior with respect to which slip systems will be the most active during plastic deformation may change as a function of the temperature at which plastic deformation occurs. Because of the temperature dependance of the critical resolved shear stress of the various slip systems, in the analysis described below, the Schmid factor on a slip plane may also be employed to simplify the analysis and selected crystallographic orientations that may be considered as hard, soft or initiator orientations. For a crystal orientation that is oriented in an arbitrary way with respect to an applied macroscopic load, the portion of the macroscopic force that is applied on these slip systems in the form of a shear stress is called the Schmid factor. Hence, a Schmid factor analysis, coupled with an understanding of which crystal orientations undergo plastic deformation in polycrystalline materials may be performed as a means to establish a link between the available crystallographic slip systems and which crystal orientations are considered to be either hard, soft or initiator orientations of polycrystalline aggregates, independent of temperature.

Determining the probability Prob_{hard}, Prob_{soft}, and Probᵢₙᵢₜ may entail determining an orientation distribution function from measurements of the crystallographic texture and the EBSD data. Then, for each of the first, second, and third microtexture regions, a probability of a specific set of orientations, dV/V, whose crystal orientation varies from g to g′ (i.e. orientations of the crystal) within a volume of possible orientations n described by the orientation distribution function, may be calculated as shown:

$$] \frac{d V}{V} = \frac{{Σ}_{g}^{{g}^{′}} g}{{Σ}_{n = 1}^{n} g}$$

Accordingly, the probability Prob_{hard}, calculated as described above, depends on the first angular range chosen for the first microtexture region and the measured orientation distribution function obtained from a representative specimen (volume) from a forging. Similarly, the probability Prob_{soft}, calculated as described above, depends upon the second angular range chosen for the second microtexture region and the measured orientation distribution function obtained from the representative specimen (volume). Finally, the probability Probᵢₙᵢₜ, calculated as described above, depends upon the third angular range chosen for the third microtexture region and the measured orientation distribution function obtained from the representative specimen (volume).

### Determination of Probability P(A)

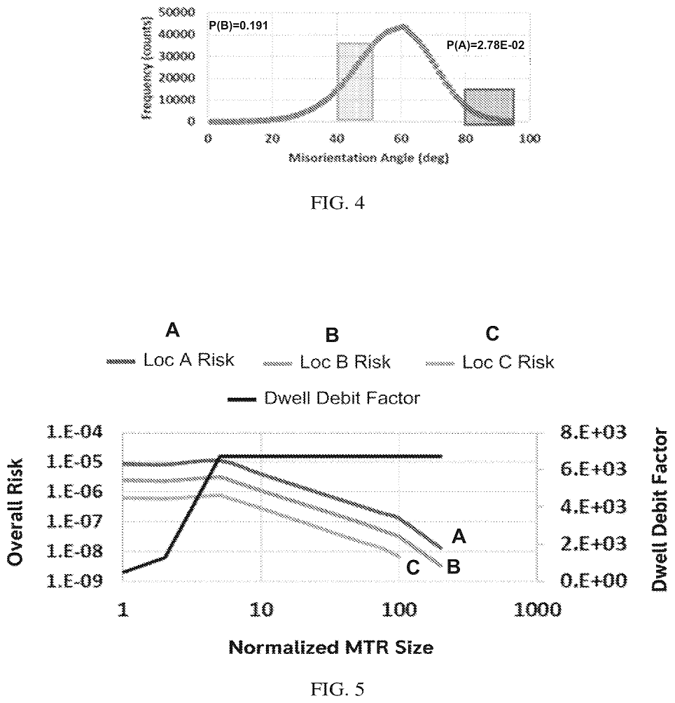

The first and second microtexture regions having hard and soft orientations, respectively, are crystallographically misaligned, in an ideal situation, ninety degrees from one another about the c-axis 110. However, there also exists some tolerance angular range for these orientations to be considered a hard orientation touching a soft orientation when a probability is calculated. In the methodology described in this disclosure, this tolerance may be chosen to be from 80 to 93 degrees with respect to one another. Hence, the quantity P(A) may be calculated by integrating the measured misorientation distribution function for a specimen between eighty and ninety-three degrees and dividing this value by the total area underneath the measured misorientation distribution function, as can be seen in reference to FIG. 4.

### Determination of Probability P(B)

Third microtexture regions having initiator orientations, are crystallographically misaligned, in an ideal situation, forty-five degrees about the c-axis 110 from the second microtexture regions having soft crystallographic orientations. In this case, the use of the misorientation distribution function may not discriminate against an initiator touch of soft or hard orientations, as both combinations of orientations fall within the same region of the misorientation distribution function measured. One may assume that the probability of a second (soft) microtexture region being in contact with a third (initiator) microtexture region is the same as a first (hard) microtexture region being in contact with a third (initiator) microtexture region, and then divide the result in half. To avoid including assumptions in the methodology, this factor of two in the probability of calculating P(B) may be ignored, as there is no easy way to partition the data. Moreover, because the risk to be calculated with the three bad crystallographic orientations approach may be calibrated with fleet data, the removal of this factor may be performed during the calibration of the three bad crystallographic orientations risk for final fleet risk assessment. Finally, for the calculation of P(B), a tolerance angle for these orientations to be considered within has been chosen to be from forty to fifty degrees with respect to one another. Hence, referring again to FIG. 4, the quantity P(B) may be calculated by integrating the measured misorientation distribution function for a sample between forty and fifty degrees and dividing this value by the total area underneath the measured misorientation distribution function.

### Determination of Probability P(MTR_{Size},Volume)

Determining the risk factor may further include determining a probability P(MTR_{Size}, Volume) of having at least one set of the first, second and third microtexture regions in the stressed volume. This probability may then be included as a multiplier with P(A), P(B), and P(C) to determine 104 the risk factor. That is, P(A)·P(B)·P(C)·P(MTR_{Size},Volume)=risk factor.

The binomial distribution may be used to calculate the probability P(MTR_{Size}, Volume) of having at least one set of the first, second and third microtexture regions in the stressed volume, which may be represented as V_{MMM} (the volume of material above the stress threshold). The number of independent Bernoulli trials n can be determined as

$$n = \frac{{V}_{M M M}}{3 {V}_{e}}$$

where Vₑ depends on the average size of the microtexture regions as determined from a Monte Carlo simulation, and the factor of 3 in the denominator represents that at least three (first, second and third) microtexture region orientations are required in V_{MMM}. The probability of success p requires the prior independent probabilities P(A), P(B) and P(C) to have occurred. Thus, the probability of success p is given by the intersection of these events or the product of the individual probabilities:

$$p = P ( A ) \cdot P ( B ) \cdot P ( C )$$

The two values determined above (n and p) are used with the binomial distribution to arrive at:

$$P ( {MTR}_{Size} , Volume ) = 1 - {( 1 - p )}^{n}$$

which may be included as a multiplier in determining 104 the risk factor as shown above.

Determination of First Scaling Factor f(% YS,MTR_{Size},% Primary Alpha)

The method may further include scaling the risk factor with a first scaling factor f(% YS,MTR_{Size},% Primary Alpha) that represents the local stress state, local microstructure and microtexture region size. In other words, the risk factor may be equivalent to the product of P(A), P(B), P(C), P(MTR_{Size},Volume) and f(% YS,MTR_{Size},% Primary Alpha), where % YS refers to percent yield strength (which refers to an applied load on the component), MTR_{size} refers to microtexture region size, and % Primary Alpha refers to primary alpha content.

This first scaling factor f(% YS,MTR_{Size},% Primary Alpha), may be based upon the dwell lives calculated by an analytical model using coupon specimens that were dwell tested for 2 minutes. These models predict the cycle to failure under two-minute dwell testing using microtexture region size, primary alpha content and load at which the dwell test is performed in terms of percent yield strength. The accuracy of this model is such that it can predict the cycles to failure of coupon specimens in most cases to within ±2X. A scaling factor may be further included as appropriate to transform component level stresses to coupon level stresses and vice versa. Based on test data and analytical equations, a factor for both Ti-6Al-4V and Ti-6242 was developed in the transformation of component stresses into coupon stresses.

The first scaling factor f(% YS, MTR_{Size},% Primary Alpha) is given by:

$$] Dwell Debit = f ( \% YS , {MTR}_{Size} , \% Primary Alpha ) = {( \frac{C T {F}_{A c t u a l}}{C T {F}_{Minimum}} )}^{2}$$

in which CTF_{actual} is the cycles to failure of the model developed for the measured microstructure (including microtexture region size and primary alpha content) at the location of interest. CTF_{Minimum} is the result of the model for the smallest MTR size, lowest primary alpha content and lowest percent yield strength that the model was trained over.

As a result of the way in which this first scaling factor has been constructed, the minimum dwell debit factor value may be 1 and the maximum value may be just over 6000. The function form of this factor (a quadratic of the ratio of the predicted dwell low cycle fatigue (LCF) lives) was selected intentionally to ensure that this present term may not overwhelm the probability calculated in the previous section and may be of equal significance. In this manner for a fixed volume of material that is above a stress threshold, as the MTR size is increased, the overall risk remains constant while the dwell debit changes from 1 to a factor just above 6000. See FIG. 5, which shows the three bad crystallographic orientations risk and dwell debit as a function of MTR size.

Determination of Second Scaling Factor f(Dwell Time)

The method may further include scaling the risk factor with a second scaling factor f(dwell time) based on a dwell time of the component at a predetermined load. In other words, the risk factor may be equivalent to the product of P(A), P(B), P(C), P(MTR_{Size},Volume), f(% YS,MTR_{Size},% Primary Alpha), and f(dwell time).

Experimental work has revealed the following behavior in Ti-6Al-4V, which suggest the benefit of including this second scaling factor. Below a set stress threshold, low cycle fatigue (LCF) and dwell LCF (DLCF) cycles to failure may be the same. This observation is consistent with the stress threshold for cold dwell in titanium alloys provided in existing design guidelines. The dwell debit observed in DLCF specimens as compared to LCF specimens increases as the load or testing stress in relation to its yield strength is increased. The dwell time imposed in DLCF testing can play a role in the dwell debit experienced by the specimen.

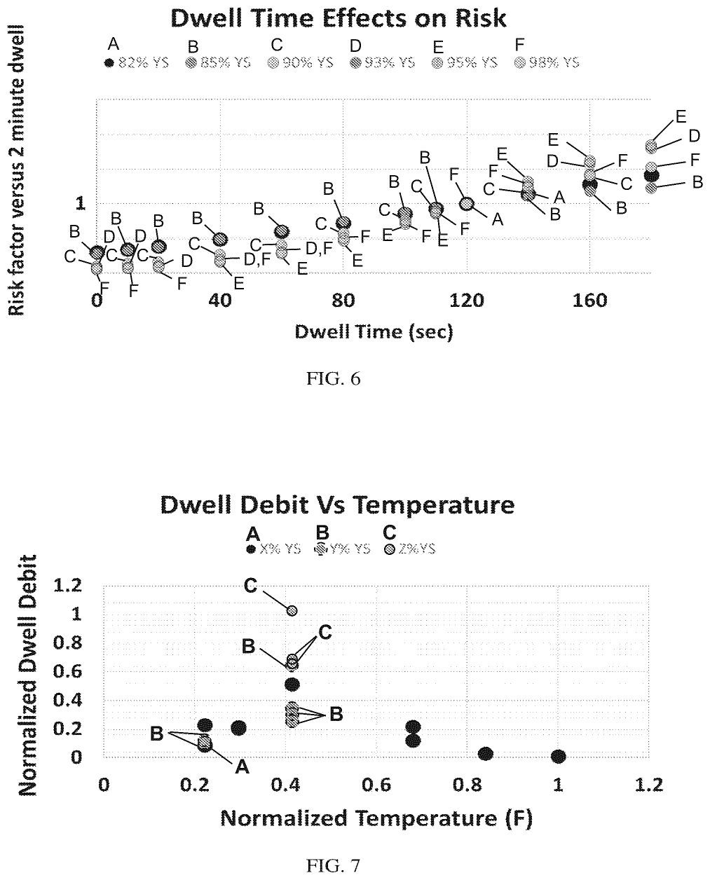

This second scaling factor to modify the risk (f(dwell time)) is developed from the fitting of a single equation to the LCF and DLCF data that is collected for a variety of loads and dwell times at a set test temperature. The results of this fitting procedure developed an equation that fit all of the measured data reasonably well over a large range of cycles to failure. Next, in order to develop the scaling factor f(dwell time), the single equation fit to the dwell data preferably converges to a value of 1 at all applied loads at a dwell time of 120 seconds (2 minutes). The rationale for this preference or requirement is that the risk associated with MTR size, primary alpha content and % YS described above already takes the applied load into account, e.g., the effects of applied load developed using coupon data that was tested with a dwell of 120 seconds. Thus, at 120 seconds f(dwell time) may converge to a value of 1 at any % YS applied. In order to accomplish this task, the risk factor f(dwell time) may be defined as the ratio of the single equation fit at the load and dwell time of interest divided by the single equation fit at the load of interest at a 120 second dwell time. The behavior of the second scaling factor f(dwell time) for a variety of loads is shown in FIG. 6.

Because the single function becomes unstable at dwell times above 180 seconds (due to the limited dwell data available above this time), in the software written, any dwell time above 180 seconds is truncated to 180 seconds. It is understood that some effects of dwell time are still observed in the measured data at 300 second dwell times and above; however, these effects are small.

Determination of Third Scaling Factor f(Temp)

The method may further include scaling the risk factor with a third scaling factor f(temp) based on an operating temperature of the component. In other words, the risk factor may be equivalent to the product of P(A), P(B), P(C), P(MTR_{Size},Volume), f(% YS,MTR_{Size},% Primary Alpha), f(dwell time), and f(temp).

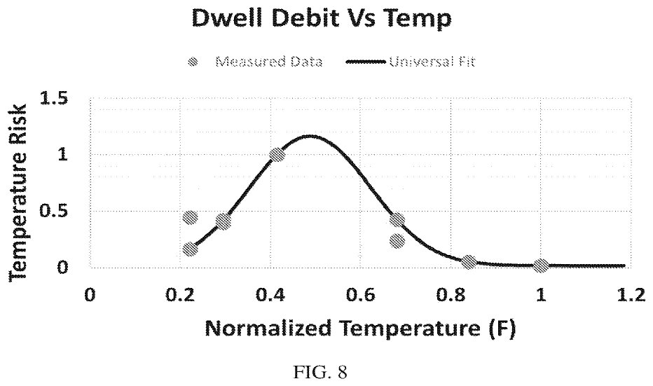

To determine this third scaling factor f(temp), dwell data are pooled into three “bins,” A % YS, B % YS, and C % YS, and dwell debit is plotted as a function of temperature, as can be seen in FIG. 7 in normalized units. A decision was made to process just the one set of YS data, the most complete data set, as % YS effects are already accounted for in another calculation. A regression fitting of the selected data is shown in FIG. 8 in normalized form. It can be seen that the third scaling factor (“temp risk”) increases as temperature rises above the lowest temperature tested, and risk decreases once a maximum dwell debit is reached.

A final step in the method, returning again to the flow chart of FIG. 1, is adjusting 106 metallurgical processing of the component based on the risk factor. As indicated above, it is understood that adjustments of the metallurgical processing of “the component” may refer to process adjustments that affect (a) the particular component that underwent the risk analysis and/or (b) like components, which may be produced at the same time or at a later time. The component may be a forged component, and the metal alloy is typically a titanium alloy.

In one example, adjusting the metallurgical processing of the component may entail altering the cooling rate during solution heat treatment to change the primary alpha content of the titanium alloy. More specifically, increasing the cooling rate may reduce the primary alpha content, whereas decreasing the cooling rate may increase the primary alpha content. Also or alternatively, adjusting the metallurgical processing of the component may include altering die geometry to change an amount of strain imparted during forging, thereby altering microtexture region (MTR) size. More specifically, altering the die geometry to increase the amount of strain may lead to a reduction in the MTR size, whereas altering the die geometry to decrease the amount of strain may lead to an increase in the MTR size. Also or alternatively, adjusting the metallurgical processing of the component may entail altering the supply of billet material to control an amount of strain prior to forging and/or the oxygen content of the titanium alloy. As indicated above, increasing the strain may reduce the MTR size, and reducing the strain may increase the MTR size. An increase in oxygen content may increase yield strength, whereas a decrease in oxygen content may lead to a decrease in yield strength.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

The subject-matter of the disclosure may also relate, among others, to the following aspects:

A first aspect relates to method of manufacturing a component comprising a metal alloy, the method comprising: measuring crystallographic texture of a volume of a component; determining a risk factor of the component for cold dwell fatigue failure; and adjusting metallurgical processing of the component based on the risk factor.

A second aspect relates to the method of the preceding aspect, wherein the component is a forged component.

A third aspect relates to the method of any preceding aspect, wherein the component comprises a titanium alloy.

A fourth aspect relates to the method of any preceding aspect, wherein the titanium alloy comprises Ti-6Al-4V, Ti-6Al-2Sn-4Zr-2Mo (“Ti 6242”), Ti-5.8Al-4.0Sn-3.5Zr-0.5Mo-0.4Si-0.3Nb-1.0Ta-0.8W-0.05C (“Ti65”), Ti-5.8Al-4.0Sn-3.5 Zr-0.7Nb-0.50Mo-0.35Si-0.06C (“IMI-834”), or another dwell-sensitive titanium alloy.

A fifth aspect relates to the method of any preceding aspect, wherein measuring crystallographic texture comprises obtaining electron backscatter diffraction (EBSD) data from the volume.

A sixth aspect relates to the method of the preceding aspect, further comprising processing the EBSD data to obtain pole figures, inverse pole figure maps, orientation distribution functions, and/or misorientation distribution functions.

A seventh aspect relates to the method of the preceding aspect, further comprising using processed EBSD data to generate a list of microtexture region sizes detected in the volume.

An eighth aspect relates to the method of the sixth or seventh aspect, further comprising determining microtexture region size distributions from maps of the EBSD data.

A ninth aspect relates to the method of any preceding aspect, wherein the volume of the component includes first microtexture regions comprising a hard crystallographic orientation with respect to a stress axis, second microtexture regions comprising a soft crystallographic orientation with respect to the stress axis, and third microtexture regions comprising an initiator crystallographic orientation with respect to the stress axis.

A tenth aspect relates to the method of the preceding aspect, wherein the first, second and third microtexture regions have a hexagonal close packed (HCP) crystal structure.

An eleventh aspect relates to the method of the ninth or tenth aspect, wherein determining the risk factor comprises: determining a probability P(A); determining a probability P(B); determining a probability P(C); and obtaining a product of the probabilities P(A), P(B), and P(C), wherein the probability P(A) is a probability of the first microtexture regions contacting the second microtexture regions; wherein the probability P(B) is a probability of the third microtexture regions contacting the first or second microtexture regions; and wherein the probability P(C) is a probability that each of the first, second, and third microtexture regions has a predetermined alignment within the volume.

A twelfth aspect relates to the method of the preceding aspect, wherein determining P(C) comprises: determining a probability Prob_{hard} of occurrence of the hard crystallographic orientation having a first predetermined alignment within the volume, the first predetermined alignment being a c-axis orientation with respect to the stress axis within a first angular range from 0 to 5 degrees; determining a probability Prob_{soft} of occurrence of the soft crystallographic orientation having a second predetermined alignment within the volume with respect to experimentally observed slip system activity in polycrystalline materials using Schmid factors, the second predetermined alignment being a c-axis orientation with respect to the stress axis within a second angular range from 80 to 90 degrees, determining a probability Probᵢₙᵢₜ of occurrence the initiator crystallographic orientation having a third predetermined alignment within the volume with respect to experimentally observed slip system activity in polycrystalline materials using Schmid factors, the third predetermined alignment being a c-axis orientation with respect to the stress axis within a third angular range from 40 to 50 degrees; and calculating a product of the probabilities Prob_{hard}, Prob_{soft}, Probᵢₙᵢₜ to obtain the probability P(C).

A thirteenth aspect relates to the method of the preceding aspect, wherein determining the probabilities Prob_{hard}, Prob_{soft}, and Probᵢₙᵢₜ comprises: determining an orientation distribution function from measurements of the crystallographic texture; and calculating, for each of the first, second, and third microtexture regions, a probability of a specific set of orientations, dV/V, whose crystal orientation varies from g to g′ within a volume of possible orientations n described by the orientation distribution function:

$$\frac{d V}{V} = \frac{{Σ}_{g}^{{g}^{′}} g}{{Σ}_{n = 1}^{n} g} .$$

A fourteenth aspect relates to the method of any of the eleventh through the thirteenth aspects, wherein determining the probability P(A) comprises: obtaining a misorientation distribution function from measurements of the crystallographic texture; integrating the misorientation distribution function between eighty and ninety-three degrees to obtain a value; and dividing the value by a total area underneath the misorientation distribution function.

A fifteenth aspect relates to the method of any of the eleventh through the fourteenth aspects, wherein determining the probability P(B) comprises: obtaining a misorientation distribution function from measurements of the crystallographic texture; integrating the misorientation distribution function between forty and fifty degrees to obtain a value; and dividing the value by a total area underneath the misorientation distribution function.

A sixteenth aspect relates to the method of any of the eleventh through the fifteenth aspects, further comprising: determining a probability P(MTR_{size},Volume) of the first, second and third microtexture regions being aligned along the stress axis within a volume of the component above a stress threshold; and multiplying the product of the probabilities P(A), P(B), and P(C) by the probability P(MTR_{size},Volume).

A seventeenth aspect relates to a method of any of the eleventh through the sixteenth aspects, further comprising: scaling the risk factor with a first scaling factor f(% YS,MTR_{Size},% Primary Alpha) representing a local stress state and microstructure of the metal alloy; scaling the risk factor with a second scaling factor f(temp) based on an operating temperature of the component; scaling the risk factor with a third scaling factor f(dwell time) based on a dwell time of the component at a predetermined load; and/or scaling the risk factor with fleet data.

An eighteenth aspect relates to the method of any preceding aspect, wherein adjusting the metallurgical processing of the component comprises: altering a cooling rate during solution heat treatment to change a primary alpha content of the titanium alloy.

A nineteenth aspect relates to the method of any preceding aspect, wherein adjusting the metallurgical processing of the component comprises: altering die geometry to change an amount of strain imparted during forging, thereby altering microtexture region size.

A twentieth aspect relates to the method of any preceding aspect, wherein adjusting the metallurgical processing of the component comprises: altering a supply of billet material to control an amount of strain prior to forging and/or an oxygen content of the titanium alloy.

In addition to the features mentioned in each of the independent aspects enumerated above, some examples may show, alone or in combination, the optional features mentioned in the dependent aspects and/or as disclosed in the description above and shown in the figures.

What is claimed is:

1. A method of manufacturing a component comprising a metal alloy, the method comprising:
measuring crystallographic texture of a volume of the component;
determining a risk factor of the component for cold dwell fatigue failure; and
adjusting metallurgical processing of the component based on the risk factor.

2. The method of claim 1, wherein the component is a forged component.

3. The method of claim 1, wherein the component comprises a titanium alloy.

4. The method of claim 3, wherein the titanium alloy comprises Ti-6Al-4V, Ti-6Al-2Sn-4Zr-2Mo (“Ti 6242”), Ti-5.8Al-4.0Sn-3.5Zr-0.5Mo-0.4Si-0.3Nb-1.0Ta-0.8W-0.05C (“Ti65”), Ti-5.8Al-4.0Sn-3.5 Zr-0.7Nb-0.50Mo-0.35Si-0.06C (“IMI-834”), or another dwell-sensitive titanium alloy.

5. The method of claim 1, wherein measuring crystallographic texture comprises obtaining electron backscatter diffraction (EBSD) data from the volume.

6. The method of claim 5, further comprising processing the EBSD data to obtain pole figures, inverse pole figure maps, orientation distribution functions, and/or misorientation distribution functions.

7. The method of claim 6, further comprising, using processed EBSD data, generating a list of microtexture region sizes detected in the volume.

8. The method of claim 6, further comprising determining microtexture region size distributions from maps of the EBSD data.

9. The method of claim 1, wherein the volume of the component includes first microtexture regions comprising a hard crystallographic orientation with respect to a stress axis, second microtexture regions comprising a soft crystallographic orientation with respect to the stress axis, and/or a third microtexture regions comprising an initiator crystallographic orientation with respect to the stress axis.

10. The method of claim 9, wherein the first, second and third microtexture regions have a hexagonal close packed (HCP) crystal structure.

11. The method of claim 9, wherein determining the risk factor comprises:
determining a probability P(A);
determining a probability P(B);
determining a probability P(C); and
obtaining a product of the probabilities P(A), P(B), and P(C),
wherein the probability P(A) is a probability of the first microtexture regions contacting the second microtexture regions;
wherein the probability P(B) is a probability of the third microtexture regions contacting the first or second microtexture regions; and
wherein the probability P(C) is a probability that each of the first, second, and third microtexture regions has a predetermined alignment within the volume.

12. The method of claim 11, wherein determining P(C) comprises:
determining a probability Prob_{hard} of occurrence of the hard crystallographic orientation having a first predetermined alignment within the volume, the first predetermined alignment being a c-axis orientation with respect to the stress axis within a first angular range from 0 to 25 degrees, or from 0 to 5 degrees;
determining a probability Prob_{soft} of occurrence of the soft crystallographic orientation having a second predetermined alignment within the volume with respect to experimentally observed slip system activity in polycrystalline materials using Schmid factors, the second predetermined alignment being a c-axis orientation with respect to the stress axis within a second angular range from 80 to 90 degrees,
determining a probability Probᵢₙᵢₜ of occurrence of the initiator crystallographic orientation having a third predetermined alignment within the volume with respect to experimentally observed slip system activity in polycrystalline materials using Schmid factors, the third predetermined alignment being a c-axis orientation with respect to the stress axis within a third angular range from 40 to 50 degrees; and
calculating a product of the probabilities Prob_{hard}, Prob_{soft}, Probᵢₙᵢₜ to obtain the probability P(C).

13. The method of claim 12, wherein determining the probabilities Prob_{hard}, Prob_{soft}, and Probᵢₙᵢₜ comprises:
determining an orientation distribution function from measurements of the crystallographic texture; and
calculating, for each of the first, second, and third microtexture regions, a probability of a specific set of orientations, dV/V, whose crystal orientation varies from g to g′ within a volume of possible orientations n described by the orientation distribution function:
$$\frac{d V}{V} = \frac{{Σ}_{g}^{{g}^{′}} g}{{Σ}_{n = 1}^{n} g}$$

14. The method of claim 11, wherein determining the probability P(A) comprises:
obtaining a misorientation distribution function from measurements of the crystallographic texture;
integrating the misorientation distribution function between eighty and ninety-three degrees to obtain a value; and
dividing the value by a total area underneath the misorientation distribution function.

15. The method of claim 11, wherein determining the probability P(B) comprises:
obtaining a misorientation distribution function from measurements of the crystallographic texture;
integrating the misorientation distribution function between forty and fifty degrees to obtain a value; and
dividing the value by a total area underneath the misorientation distribution function.

16. The method of claim 11, further comprising:
determining a probability P(MTR_{size},Volume) of the first, second and third microtexture regions being aligned along the stress axis within a volume of the component above a stress threshold; and
multiplying the product of the probabilities P(A), P(B), and P(C) by the probability P(MTR_{size},Volume).

17. The method of claim 11, further comprising:
scaling the risk factor with a first scaling factor f(% YS,MTR_{Size}, % Primary Alpha) representing a local stress state and microstructure of the metal alloy;
scaling the risk factor with a second scaling factor f(temp) based on an operating temperature of the component;
scaling the risk factor with a third scaling factor f(dwell time) based on a dwell time of the component at a predetermined load; and/or
scaling the risk factor with fleet data.

18. The method of claim 1, wherein adjusting the metallurgical processing of the component comprises:
altering a cooling rate during solution heat treatment to change a primary alpha content of the titanium alloy.

19. The method of claim 1, wherein adjusting the metallurgical processing of the component comprises:
altering die geometry to change an amount of strain imparted during forging, thereby altering microtexture region size.

20. The method of claim 1, wherein adjusting the metallurgical processing of the component comprises:
altering a supply of billet material to control an amount of strain prior to forging and/or an oxygen content of the titanium alloy.
